(19) United States
(12) Patent Application Publication
(10) Pub. No.: US 2012/0096565 A1
(43) Pub. Date: Apr. 19, 2012

(54) DEVICE, METHOD AND SYSTEM TO PREVENT TAMPERING WITH NETWORK CONTENT

(75) Inventors: Huaigu Ou, Beijing (CN); Zhixu Liu, Beijing (CN); Zujun Xu, Beijing (CN); Tiejun Wu, Beijing (CN); Mingfeng Huang, Beijing (CN); Yanlong Zhang, Beijing (CN)

(73) Assignee: NSFOCUS INFORMATION TECHNOLOGY CO., LTD., Beijing (CN)

(21) Appl. No.: 13/319,545

(22) PCT Filed: May 11, 2010
(86) PCT No.: PCT/CN10/00674

§ 371 Date: Dec. 30, 2011

(30) Foreign Application Priority Data
May 11, 2009 (CN) 200910083751.3

(51) Int. Cl. G06F 21/00; G06F 15/16; G06F 11/30

(52) U.S. Cl. 726/26

(57) ABSTRACT

The present invention discloses a system for preventing network content of one or more network servers from being tampered with. The system comprises a content caching and providing device to cache network content of the one or more network servers; and a content monitoring sub-system with one or more content monitoring client incorporated in the network servers respectively and a content monitoring server part incorporated in the content caching and providing device. The present invention further discloses a content caching and providing device, a network content providing system and a corresponding method. With the system, device and method according to the present invention, we can improve the speed and security of accessing network content while effectively preventing the network content from being tampered with.

This application is a 35 U.S.C. 371 national phase filing of PCT/CN2010/000674, filed May 11, 2010, which claims priority to Chinese patent application 200910083751.3, filed May 11, 2009, the disclosures of which are incorporated herein by reference in their entireties.

### TECHNICAL FIELD

The present invention relates to the field of network server security, in particular, to a device, method and system for preventing network content of a network server from being tampered with, and a computer program product and a recording medium for implementing such method.

### BACKGROUND ART

With the advent of the information age, network servers that provide various kinds of content information service in the network become more and more popular. For many reasons, e.g., vulnerabilities of the operation system used by the network server per se or wrong settings made by the administrator of the network server, hackers can modify the network content provided by the network server without authorization, where the network content is modified to contain content of improper information so that users browsing through the network content of the network server acquire wrong information, which brings considerable damage to the owner of the network server and the provider of the content.

In response, many methods in the prior art have been proposed to prevent the network content of a network server from being tampered with.

One of them is to install dedicated software in the network server to monitor the content of files in the server in real time. When the content of a file is found to be tampered, a backup of the file is directly adopted to overwrite the tampered file.

However, the above approach of preventing network content from being tampered with has several disadvantages. Firstly, it needs to install dedicated software in the network server, if the software per se has security problems, it will bring hidden risk to the security of the network server. Secondly, as the software runs in the network server, if the right of the network server acquired by a hacker is high enough, the hacker may probably have the right to deactivate the software, and as a result, the software will become completely useless. Thirdly, as the software has to coordinate with applications that provide network content service in the network server (e.g., HTTP servers, etc.), an administrator of the network server has to change his work procedure, which increases the workload of the administrator. Besides, since the software simply overwrites the tampered file rather than directly takes measures to find out the reasons why the file has been tampered, the hacker who has intruded into the network server may modify the file for a second time, which will bring instability to the network server.

Another approach is to arrange a hardware protection device in front of the network server to prevent the network content from being tampered with, where the hardware protection device acquires files under protection from the server periodically and compares them with the standard files stored in the hardware protection device to determine whether they have been tampered with. If the files are found to be tampered, the hardware protection device will react with a take-over action and an alarm action. Generally, the take-over content is uniform content carried by the hardware protection device per se.

However, such an approach of preventing network content from being tampered with a hardware protection device also has many disadvantages. Firstly, the determination of network content being tampered with in such an approach is made by acquiring the network content under protection from the server at certain intervals and comparing it with the standard content stored in the hardware protection device, so there is a possibility that the tampered network content has been seen by the user who requests to browse through the network content prior to the determination of the hardware protection device, and this will bring considerable damage to the content provider of the network content service. Secondly, the hardware protection device unremittingly polls the files in the server, if the number of files under protection is huge, this must affect the performance of the network device, resulting in slowness of access to the network server. Thirdly, if a tamper occurs, the user usually sees the take-over content carried by the hardware protection device per se which is different from the content before the tamper. In some sense, the network content has also been tampered with and the tamper has been perceived by the user.

It can be seen that the current approaches for preventing network content from being tampered with are all somewhat defective. Furthermore, the above methods do not considerate the speed of accessing the network content by the user, but only how to prevent the network content from being tampered with. Generally speaking, as extra processing is needed to prevent the network content from being tampered with, extra expenses of the network server are usually required, which reduces the performance of the server for providing network content, and this is adverse for the popularization of the device or system for preventing a network content from being tampered with.

Therefore, the present invention attempts to provide a new device, method and system for preventing a network content from being tampered with to avoid the problems existing in the prior art and meanwhile to improve the speed of accessing the network content by the user.

### SUMMARY

According an aspect of the present invention, a system for preventing network content of one or more network servers from being tampered with is provided, comprising: a content caching and providing device, for caching network content of the one or more network servers, processing requests for accessing the network content from users, responding to the requests for accessing the network content from the users with the cached network content; and a content monitoring sub-system, comprising one or more content monitoring client units incorporated in the network servers respectively and a content monitoring server unit incorporated in the content caching and providing device; wherein said one or more content monitoring client units monitor an update of the network content in said one or more network servers respectively, and send the update of the network content to the content monitoring server unit; the content monitoring server unit determines whether the update of the network content is a tamper based on predetermined temper determination rules; when the update of the network content is determined to be the tamper, the corresponding network content cached in the caching and providing device is not updated; when the update of the network content is determined not to be the tamper, the content caching and providing device is designated to update the cached network content of the one or more network servers.

According to a further aspect of the present invention, a content caching and providing device is provided, comprising: a network content cache, wherein network content of one or more network servers is cached; a network server proxy unit for processing requests from the users for accessing the network content of the one or more network servers, and responding to the users' access requests with the network content cached in the network content cache; a content updating unit for acquiring the network content of the one or more network servers and updating it to the network content cache; and a content monitoring server unit for communicating with one or more content monitoring client units respectively incorporating into said one or more network servers so as to acquire update information about the network content in said network servers and to determine whether the update of the network content is a tamper or not based on predetermined tamper determination rules, when the update of the network content is determined to be a tamper, the corresponding network content cached in the network content cache is not updated; when the update of the network content is determined not to be a tamper, the content updating unit is designated to update the cached network content in one or more network servers.

According to a further content of the present invention, a network content providing system is provided, comprising: one or more network servers, where network content to be provided is stored thereon; and a system for preventing the network content of the one or more network servers from being tampered with as mentioned before.

According to a further aspect of the present invention, a method for preventing network content of one or more network servers from being tampered with is provided, said method is implemented in a system for preventing the network content from being tampered with, and the system comprises a content caching and updating device for caching the network content of said one or more network servers. The method comprising steps of: monitoring the network content of one or more network servers; generating information about a change in the network content when the change in the network content of said one or more network servers is detected; determining whether the change in the network content corresponding to the update event of the network content is a normal content update or an abnormal content tamper according to predetermined tamper determination rules; updating the cached network content if the network content update is the normal content update; and not updating the cached network content if the network content update is the abnormal content tamper.

The approach for preventing network content from being tampered with as proposed in the present invention comprises using a content caching and providing device disposed at the front of the network server. As the content caching and providing device caches content of the network server, a user accessing the content of the network servers acquires the network content from the content caching and providing device directly without acquiring the content of the network servers via the content caching and providing device. Thereby, the speed of accessing the network content by the user is improved. In addition, the content caching and providing device is usually a specially designed hardware device, which is usually optimized for network storage and hence responds to the user more rapidly than the network server, and this further improves the speed of accessing the network content by the user.

The approach for preventing network content from being tampered with as proposed in the present invention further comprises using a network content monitoring system. The network content monitoring system is a distributed system, comprising a content monitoring client unit closely cooperating with or incorporating into the network server, and a content monitoring server unit closely cooperating with or incorporating into the content caching and providing device. The content monitoring client unit is incorporated into the network server and hence may have a risk of being intruded and tampered with together with the network server without permission, but it is not easy for the content monitoring server unit to be intruded and tampered with without permission because it is incorporated into the content caching and providing device which has a higher security level, whereas dedicated communication between the content monitoring server unit and the content monitoring client unit enables rapid perception of abnormalities at the content monitoring client unit. Therefore, compared with the approach of installing special software in the network server, the approach as proposed in the present invention has much higher security.

### DESCRIPTION OF FIGURES

Other advantages and benefits of the present invention will be clear and obvious to those skilled in the art from the detailed description of the embodiments in the following description. The drawings are only used for the purpose of illustration and should not be construed as limiting the invention. The same reference signs represent the same components throughout the drawings, where the letter signs following the reference number indicate a plurality of same components, and when these components are referred to as a whole, the last letter signs will be omitted, specifically:

FIG. 1 shows a layout for providing network content by a network content providing system 100 according to an embodiment of the present invention;

FIG. 2 shows a detailed diagram of a system 110 for preventing the network content from being tampered with according to an embodiment of the present invention; and

FIG. 3 shows a method 300 for preventing the network content from being tampered with according to an embodiment of the present invention.

### DETAILED DESCRIPTION

Further descriptions of the present invention are given as follows in combination with the figures and the specific embodiments.

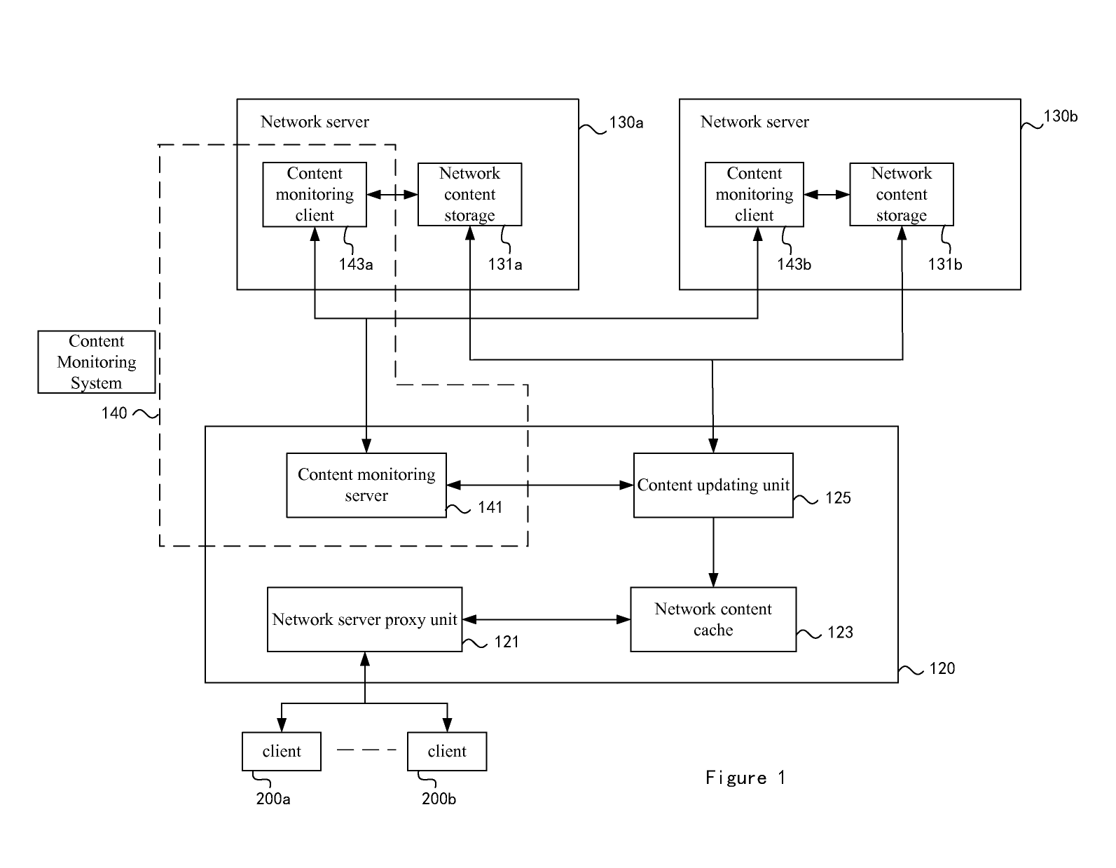

FIG. 1 shows a layout for providing network content by a network content providing system 100 according to an embodiment of the present invention.

In the network content providing system 100, a system 110 for preventing the network content from being tampered with is provided to process requests for accessing content from the client. The system 110 comprises a content caching and providing device 120 and a content monitoring sub-system 140. The content monitoring sub-system 140 is a distributed system comprising a content monitoring server 141 which cooperates with and is preferably incorporated into the content caching and providing device 120, and content monitoring clients 143a and 143b which cooperate with and are preferably incorporated into network servers 130a and 130b. The content monitoring client 143 is used to monitor changes in the network content of the network server and to inform the changes to the content monitoring server 141 by which the operation of content caching and providing device 120 is controlled. The network content providing system 100 may comprise one or more network servers 130, so corresponding number of content monitoring clients 143 are also required. The content monitoring server 141 may communicate with a plurality of content monitoring clients 143 simultaneously so as to monitor the network content of a plurality of network servers 130. The content monitoring server 141 and the content monitoring client 143 can communicate in any manners, but an encrypted manner is preferred so as to make sure that the communication content between them is not known by a third party. In addition, a heartbeat detection based on heartbeat protocols, for example, is executed between the content monitoring server 141 and the content monitoring client 143 to detect whether the communication between the content monitoring server 141 and the content monitoring client 143 is in work. Of course, all of any other detection techniques capable of detecting whether the communication between the content monitoring server 141 and the content monitoring client 143 is in work fall within the protection scope of the present invention.

The content caching and providing device 120 comprises a network server proxy unit 121, a network content cache 123 and a content updating unit 125. The network content cache 123 caches network content of network servers 130a and 130b. The content updating unit 125 updates the content in the network content cache 123 based on information from the content monitoring sub-system 140, especially information from the content monitoring server 141, so as to keep consistency between the content of network server 130 and the content cached in the network content cache 123.

Prior to or at the beginning of the application of the network content providing system 100, or when a new network server 130 is added into the network content providing system 100, any methods can be utilized to copy the network content stored in a memory 131 of the network server 130 to the network content cache 123 of the content caching and providing device 120. This can be done, for example, manually by the network administrator. This can also be implemented in the manner that the content monitoring client 143 sends a message of updating all network content to the content monitoring server 141, and subsequently the content monitoring server 141 indicates the content updating unit 125 to update all network content of the network server 130 to the network content cache 123. All of these methods for caching network content of the network content server 130 to the network content cache 123 fall within the protection of the present invention.

During the operation of the network content providing system 100, users at a plurality of clients 200a, . . . , 200b, etc. send requests for network content to the network content providing system 100. The network content is initially stored in the network content memories 131a and 131b of the network servers 130a and 130b, and the users request to access network content stored in the network servers 130a and 130b. In the network content providing system 100, the content caching and providing device 120 has cached the content of each network server 130 in the network content cache 123. The content caching and providing device 120 is arranged between the network server 130 and client 200, so requests for network content of the network server 130 from all users must pass the content caching and providing device 120. The network server proxy unit 121 processes network content requests from the users, and when the requested content is network content of the network server 130, the network content cached in the network content cache 123 is directly used in response.

It can be seen from the above that, in the network content providing system 100, the network content cached in the network content cache 123 of the content caching and providing device 120 is provided in response to the users' requests for accessing content, and when the network content of the network server 130 changes, the content monitoring sub-system 140 and the content updating unit 125 cooperate to update the changed content to the network content cache 123.

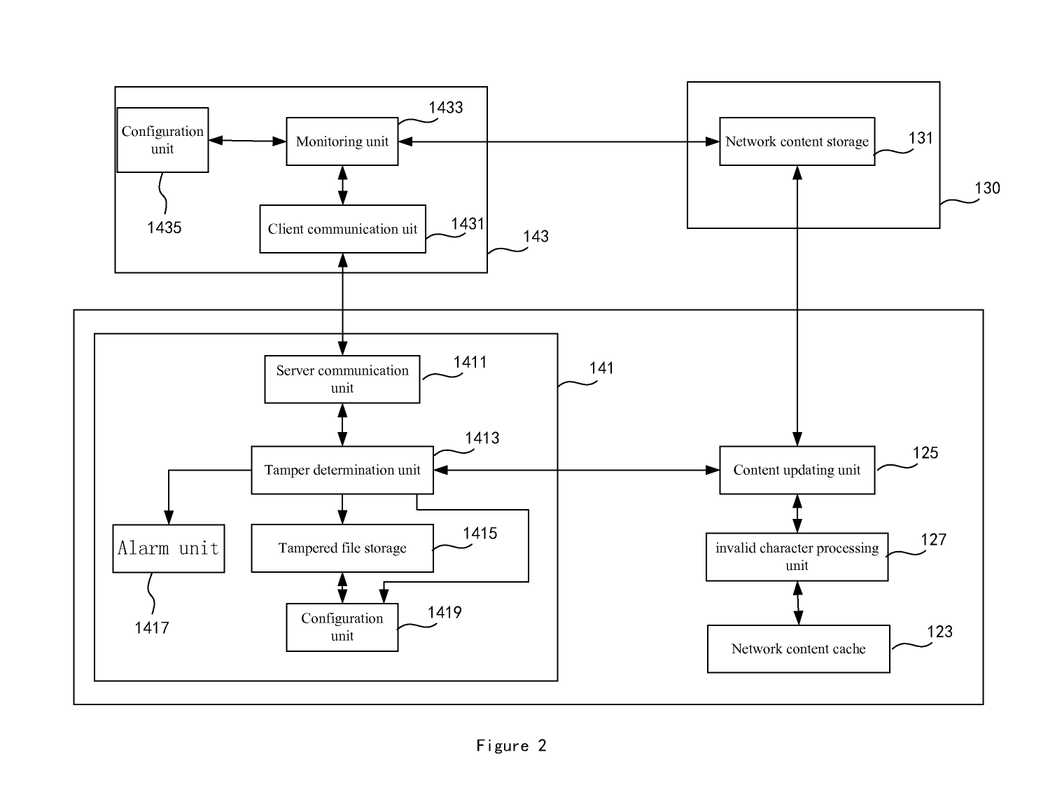

However, when the network content of the network server 130 is tampered with without permission, it is improper to update the tampered content to the network content cache 123 and present it to the user. The network content providing system 100 can detect such unauthorized tampers, and prevent the users from perceiving the tampered network content. In combination with FIG. 2, how the network content providing system 100 prevents the network content from being tampered with is described bellow.

FIG. 2 shows a detailed diagram of a system 110 for preventing the network content from being tampered with in the network content providing system 100 according to an embodiment of the present invention.

The content monitoring client 143 comprises a client communication unit 1431, a monitor unit 1433 and a configure unit 1435.

The client communication unit 1431 communicates with a corresponding server communication unit 1411 of the content monitoring server 141. As mentioned above, the communication can be carried out in any manners, but a particular encrypted manner between them is preferred to ensure the security of the content to be communicated.

The monitor unit 1433 monitors the network content stored in the network content memory 131 of the network server 130 in real time. There are many methods that can be employed for a real-time monitoring of the network content. For instance, the network content is usually stored in the network content memory 131 in the form of files, and the current computer operating system is usually designed hierarchically, so the monitor unit 1433 can monitor the low level interface for accessing the files by a HOOK manner and hence is able to monitor in real time the modification of the network content. Of course, the above manner is only exemplary, and all of any methods that can monitor the modification of the network content in real time fall under the protection scope of the present invention. When the monitor unit 1433 detects a change in the network content under monitoring, a network content update event is generated and sent via the client communication unit 1431 to the content monitoring server 141 for further processing. Generally, the network content update event generated by the monitoring unit 1433 usually comprises the network content identifier (e.g., a title of the file, a path of the file, a file ID etc.), the update type (e.g., new, modification, deletion etc.), update time and so on. Prior to sending the event to the content monitoring server 141, the client communication unit 1431 usually adds a server identifier in the event. It should be noted that the contents of the network content update event can include more or different contents depending on the requirement of the content monitoring server 141, for instance, the application updating the content, the user, the level of the user and so on. These can all be conceived by one skilled in the art and hence fall under the protection scope of the present invention.

The configuration unit 1435 interacts with the system administrator to receive the configuration information about the content monitoring client 143, the content of the configuration information comprises the setting of network content to be monitored, etc. For example, when the network content is stored in the network content memory 131 in the form of files, the configuration information can comprise the file list of the network content or the file catalog of the network content and the like.

The content monitoring server 141 comprises a server communication unit 1411, a tamper determination means 1413, storage 1415 for storing the tampered files, an alarm unit 1417 and a monitor server configuration means 1419.

As aforementioned, the server communication unit 1411 is configured to communicate with the client communication unit 1431 to receive the network content update event sent by the content monitoring client 143 and sending the network content update event to the tamper determination unit 1413 for further processing. Besides, additional communication is further carried out between the server communication unit 1411 and the client communication unit 1431 to ensure that the communication between the content monitoring server 141 and the content monitoring client 143 is in work. Such additional communication can be, e.g. a heartbeat detection based on heartbeat protocols. The content monitoring client 143 hosts in the network server 130, and when the network server 130 cuts off the communication with the content monitoring server due to some reasons (e.g. intruded by a hacker and shutting down the content monitoring client), the server communication unit 1411 can detect the cutoff of the network through the additional communication and generate a network server cutoff event and inform the network administrator by means of the alarm unit 1417.

The tamper determination unit 1413 determines whether the received network content update event indicated normal update or not based on the preconfigured tamper determination rules. If it is determined that the update of the network content belongs to a normal update, the network server identifier, the network content identifier and update type comprised in the network content update event are extracted, and such extracted information is sent to the content update unit 125. The content update unit 125 firstly determines the update type, and if the update type is deletion, the corresponding content in the network content cache 123 is deleted directly; otherwise, the corresponding network content is acquired from the corresponding network server according to the network server identifier and the network content identifier and the newly acquired network content is used to update the corresponding content in the network content cache 123. If the tamper determination unit 1413 determines that the network content update belongs to a tamper, i.e., a modification without permission, the tamper determination unit 1413 will not inform the content update unit 125 to update the network content, in addition, the tamper determination unit 1413 will add the tampered content into a storage 1415 for storing the tampered files and inform the network administrator via the alarm unit 1417 that the corresponding network content has been tampered with.

The storage 1415 stores a list of the tampered files, wherein each item in the list records information about the tampered files, such as file identifier, network server identifier, tamper type (which is usually the same as the update type, including new, modification and deletion etc.), tamper time and the like. Therefore, such information can all be extracted from the network content update event. In addition, as mentioned above, the application tampering the content, the user, the level of the user and so on can also be recorded.

The alarm unit 1417 receives information sent by any other unit, and informs the network administrator of the information in the form of emails, messages and so on. As understood by one skilled in the art, any other manners for informing the network administrator of the information can all be implemented in the alarm unit 1417 and hence fall within the protection scope of the present invention.

The monitor server configuration unit 1419 is used to configure and manage the content monitoring server 141, for example, the network administrator can configure the tamper determination rules, check the list of tampered files and so on via the configuration unit 1419.

It should be pointed out that, the tamper determination rules can be various kinds of rules and any combinations of these rules. For example, an ordinary tamper determination rule is a rule based on the modification time of the network content, i.e., if the network content is modified within a predetermined time period, the modification is deemed as a normal modification. In contrast, modifications out of the predetermined time period are deemed as tampers of the network content without any permission. Another tamper determination rule deems modifications of the network content made by a certain application as normal modifications and the else as tampers. A further tamper determination rule deems modifications of the network content by a certain user or user of a certain level as normal modifications and the else as tampers. One skilled in the art can conceive of other tamper determination rules upon requirement, and all of tamper determination rules fall under the protection scope of the present invention.

It should be further pointed out that the network content update event sent to the content monitoring server 141 from the content monitoring client 143 can add corresponding contents upon the requirement of the tamper determination rules. For example, if the tamper determination rules involve the application or the user which modifies the network content, information about the related application or user should be added into the network content update event.

Alternatively, the content caching and providing device 120 can further comprise an invalid characters processing unit 127 for inspecting the content of the network content acquired by the content updating unit 125. When it is found that the acquired network content comprises invalid characters, the network content can be prevented from being updated to the network content cache 123, and the event can be recorded and the network administrator can be informed in all ways. In this case, the invalid characters processing unit 127 can record the related events in the storage 1415 for storing tampered files and inform the network administrator of the event via the alarm unit 1417.

It can be seen that the system 110 for preventing the network content from being tampered with can monitor the update of the network content of the network server 130 in real time and update the network content to the content cache 123, such that the user can see the updated network content timely. Furthermore, when the network content of the network server is tampered with, the content monitoring sub-system 140 can monitor the tamper and will not update the tampered network content to the content cache 123. From the view of the user, the network content remains untampered. In this way, the system 110 can protect the network content from being tampered with in a manner completely transparent to the user.

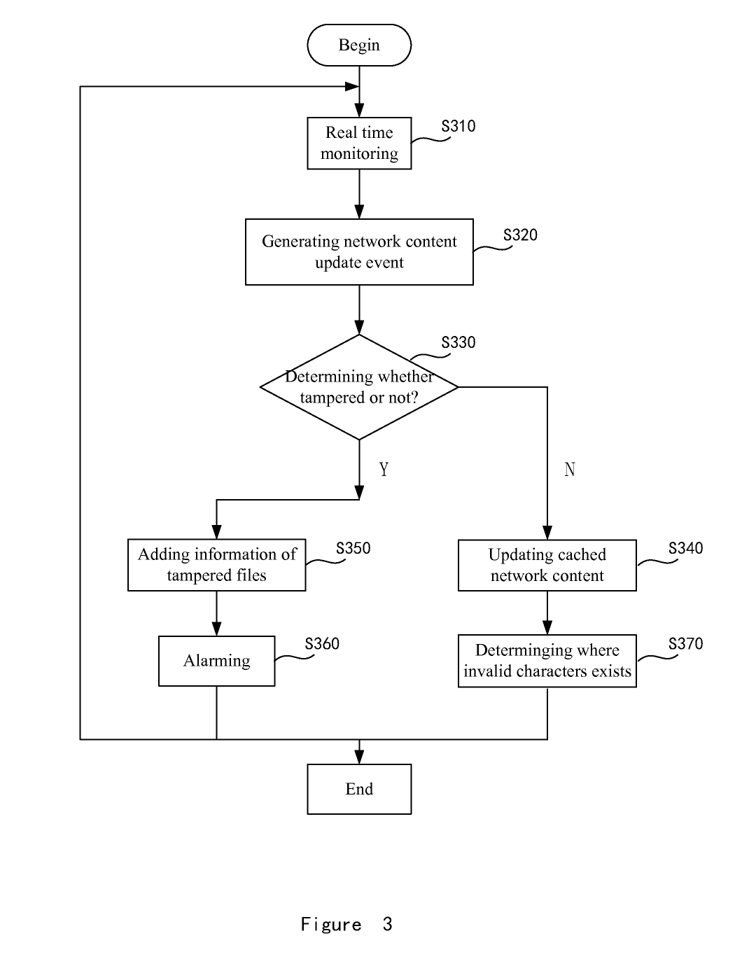

FIG. 3 shows a method 300 for preventing the network content from being tampered with using the system 110 according to an embodiment of the present invention.

At step S310, the network content of the network server is monitored in real time to detect any changes in the network content, and this is usually performed by the content monitoring client 143. At step S320, when any changes in the network content of the network server have been monitored (including the deletion, modification and increase of the network content), the content monitoring client 143 generates a network content update event and transmits the event to the content monitoring server 141 for further processing. At step S330, the content monitoring server 141 determines whether the network content update corresponding to the network content update event is a normal content update or an abnormal content tamper according to the tamper determination rules. If the content update is a normal content update, at step S340, the content updating unit 125 update the network content cached in the content cache 123 according to the network content update event. If the content update is an abnormal content tamper, at step S350, information about the tampered file will be added to the storage 1415 for storing tampered files, and then at step S360, the network administrator will be informed of the tamper event.

Besides, alternatively, the method 300 further comprises step S370 for determining whether the updated network content contains invalid characters before the content updating unit 125 updates the network content. If there are invalid characters, the network content update will be prevented, otherwise, the network content update will be allowed.

Subsequently, the processing in method 300 returns to step S310 to continue monitoring the update of the network content. In the above description of the method 300, for the sake of briefness, portions similar to the description of the system 110 for preventing the network content from being tampered with are omitted.

It should be noted that, in the present invention, network content refers to any content that can be provided to the network user, e.g., including but not limitation to web pages, photos, script files and downloadable files, etc. The network content is usually stored in the network content server 130 in the form of files.

To sum up, it can be seen that the present invention uses jointly the content monitoring sub-system and the content caching and providing device to prevent the tamper of network content of the network server from being perceived by the user, and informs the network administrator timely when the network content of the network server is tampered with so as to find out the source of the tamper and restore the network content in time. In the present invention, the content monitoring sub-system is a distributed system and the client unit is embedded in the network server and the server unit is embedded in the content caching and providing device. As the content caching and providing device is usually a dedicated device and hence has high security, compared with the network server, it is more difficult for the content caching and providing device to be intruded illegally. For example, the content caching and providing device can even be connected between the user and the network server in a transparent manner, so the external user may even not perceive its existence, which will considerably reduce the probability of being intruded illegally. Although the content monitoring client is also embedded in the network server, the dedicated connection between the content monitoring server and the content monitoring client can also enable the content monitoring server to detect the abnormalities of the content monitoring client timely, so when the content monitoring client cannot work normally due to illegal intrusions into the network server, the network administrator can also find the problem timely and address himself/herself to it with the system for preventing the network content from being tampered with according to the present invention.

It should be noted that in the system for preventing the network content from being tampered with and the content caching and providing device according to the present invention, components therein are logically divided in light of the functions to be achieved. However, the present invention is not limited by this and the components of the system for preventing the network content from being tampered with and the content caching and providing device can be redivided or recombined upon requirement, for instance, some components can be combined as an individual component or some components can be further divided into more sub-components.

The embodiments of the present invention can be carried out by hardware or by software modules run on one or more processors, or by the combination of the two. One skilled in the art should understand that microprocessors or digital signal processors (DSP) can be used to carry out same or all of the functions of some or all of the components of the system for preventing the network content from being tampered with and the content caching and providing device in accordance with the embodiments of the present invention in practice. The present invention can further be implemented as device or programs (for example, computer programs and computer program products) for executing part or all of the method described herein. Such programs carrying out the present invention can be stored in a computer-readable medium, or have the form of one or more signals. Such signals can be downloaded from Internet networksites or provided by a carrier signal or provided in any other forms.

It should be noted that the above embodiments illustrate rather than limit the invention, and that those skilled in the art will be able to design alternative embodiments without departing from the scope of the appended claims. In the claims, any reference signs placed between parentheses shall not be construed as limiting the claim. The word “comprise” does not exclude the existence of elements or steps other than those listed in a claim. The word “a” or “an” preceding an element does not exclude the existence of a plurality of such elements. The present invention can be achieved by means of hardware comprising several different elements and by means of an appropriately programmed computer. In unit claims listing several means, several of these means can be embodied by one and the same item of hardware. The use of ordinal words such as first, second and third does not represent any order, but instead, they can be understood as titles.

1. A system for preventing network content of one or more network servers from being tampered with, comprising:
a content caching and providing device for caching the network content of the one or more network servers, processing requests for accessing the network content from users, responding to the requests for accessing the network content with the cached network content;
and a content monitoring sub-system, comprising one or more content monitoring client units incorporated in the network servers respectively and a content monitoring server unit incorporated in the content caching and providing device;
wherein said one or more content monitoring client units monitor an update of the network content on said one or more network servers respectively, and send the update of the network content to the content monitoring server unit;
and wherein the content monitoring server unit determines whether the update of the network content belongs to a tamper or not based on predetermined tamper determination rules, and if the update of the network content is determined to be to a tamper, the corresponding network content cached in the caching and providing device is not updated, and if the update of the network content is determined not to be a tamper, the content caching and providing device is instructed to update the cached network content in one or more network servers based on the update of the network content on said one or more network servers.

2. The system according to claim 1, wherein the content caching and providing device comprises:
a network content cache, wherein the network content of one or more network servers is cached;
a network server proxy unit being configured to process the requests for accessing the network content from the users, and responding to the requests for accessing the network content from the users with the network content cached in the network content cache; and
a content updating unit being configured to acquire the network content of one or more network servers according to an instruction from the content monitoring server unit, and updating the acquired network content to the network content cache.

3. The system according to claim 1, wherein each content monitoring client unit incorporated in one of the one or more network servers comprises:
a client communication unit being configured to communicate with the content monitoring server unit;
a monitor unit being configured to monitor in real time the network content stored in said one of the one or more network servers, and generate a network content update event when the stored network content is updated, and send the network content update event via the client communication unit to the content monitoring server unit, wherein the network content update event comprises a network content identifier, a network server identifier, an update time and an update type.

4. The system according to claim 3, wherein the content monitoring server unit comprises:
a server communication unit being configured to communicate with the content monitoring client unit;
a tamper determination unit being configured to determine whether a network content update comprised in the network content update event is a tamper or not based on the predetermined tamper determination rules, and if the network content update is a normal update, instruct the content caching and providing device to update the cached corresponding network content, and if the network content update is a tamper, extract information from the network content update event and add the extracted information into a storage for storing tampered files; and
the storage for storing the tampered files being configured to store information about the tampered network content.

5. The system according to claim 4, wherein the client communication unit communicates with the server communication unit in an encrypted manner.

6. The system according to claim 1, wherein the predetermined tamper determination rules include any one or more of the following:
the update time of the network content falls within the predetermined time period;
the network content is updated by a particular application; and
the network content is updated by a particular network server user or user level.

7. The system according to claim 2, wherein the content caching and providing device further comprises a invalid character processing unit being configured to prevent the update of corresponding network content in the network content cache if the network content to be updated comprises invalid characters.

8. A content caching and providing device, comprising:
a network content cache, wherein network contents of one or more network servers is cached;
a network server proxy unit being configured to process requests for accessing the network contents of one or more network servers from users, and responding to the requests for accessing from the users with the network contents cached in the network content cache;
a content updating unit being configured to acquire the network contents of one or more network servers and updating the acquired network contents to the network content cache; and
a content monitoring server unit being configured to communicate with one or more content monitoring client units incorporated into said one or more network servers respectively so as to acquire update information about the network content of the network servers and to determine whether the update of the network content is a tamper based on predetermined tamper determination rules, wherein if the update of the network content is determined to be a tamper, the corresponding network content cached in the network content cache is not updated; if the update of the network content is determined not to be a tamper, the content updating unit is instructed to update the cached network content of one or more network servers.

9. The content caching and providing device according to claim 8, further comprising:
an invalid character processing unit being configured to prevent the update of corresponding network content in the network content cache if the network content to be updated comprises invalid characters.

10. The content caching and providing device according to claim 8, wherein the content monitoring server unit comprises:
a server communication unit being configured to communicate with the content monitoring client unit;
a tamper determination unit being configured to determine whether the network content update comprised in the network content update event is a tamper or not based on the predetermined tamper determination rules, and if the network content update is a normal update, instruct the content caching and providing device to update the cached corresponding network content, and if the network content update is a tamper, extract information from the network content update event and add the extracted information into a storage for storing tampered files; and
a storage for storing the tampered files being configured to store information about the tampered network content.

11. The content caching and providing device according to claim 8, wherein the predetermined tamper determination rules include any one or more of the following:
the update time of the network content falls within the predetermined time period;
the network content is updated by a particular application; and
the network content is updated by a particular network server user or user level.

12. A network content providing system, comprising:
one or more network servers, wherein network content to be provided is stored; and
a system for preventing network content of the one or more network server from being tampered with according to claim 1.

13. A method for preventing network content of one or more network servers from being tampered with, said method being implemented in a system for preventing network content from being tampered with, the system comprising a content caching and updating device being configured to cache the network content of one or more network servers, the method comprising:
monitoring network contents of the one or more network servers;
generating information about the change in the network content when a change in the network content in said one or more network servers is detected;
determining whether the change in the network content is a normal content update or an abnormal content tamper according to the predetermined tamper determination rules;
updating the cached network content if the network content update is a normal content update; and
not updating the cached network content if the network content update is an abnormal content tamper.

14. The method according to claim 13, further comprising:
recording the tampered network content and generating an alarm if the network content update is an abnormal content tamper.

15. The method according to claim 13, wherein the predetermined tamper determination rules include any one or more of the following:
the update time of the network content falls within the predetermined time period;
the network content is updated by a particular application; and
the network content is updated by a particular network server user or user level.

16. A computer program product, comprising instructions for implementing the steps of the method according to claim 13 when being loaded into a computer and running thereon.

17. A recording medium, where instructions for implementing the steps of the method according to claims 13 when being loaded into a computer and running thereon are stored thereon.
